(19) United States
(12) Patent Application Publication
(10) Pub. No.: US 2026/0288224 A1
(43) Pub. Date: Sep. 24, 2026

(54) SLEEP AND WAKE MANAGEMENT IN A CHIPLET-BASED SYSTEM

(71) Applicant: QUALCOMM Incorporated, San Diego, CA (US)

(72) Inventors: Zhurang ZHAO, San Diego, CA (US); Joshua STUBBS, Longmont, CO (US); Sathish Kumar MASILAMANI, San Diego, CA (US)

(21) Appl. No.: 19/088,821

(22) Filed: Mar. 24, 2025

(51) Int. Cl. G06F 1/3287; G06F 1/3215

(52) U.S. Cl. CPC G06F 1/3287; G06F 1/3215

(57) ABSTRACT

A chiplet-based system is provided in which each chiplet includes a power manager. One of the power managers is a primary power manager that coordinates with the remaining power managers after all the chiplets have transitioned to a deep-sleep state in which their resources are powered down to power down each chiplet's die-to-die control plane interface to transition the chiplet-based system to a low-power mode of operation.

### TECHNICAL FIELD

The present application relates generally to chiplets, and more particularly to a chiplet-based system with sleep and wake management.

### BACKGROUND

Portable computing devices (“PCDs”) are becoming necessities for people on personal and professional levels. These devices may include cellular telephones, portable digital assistants (“PDAs”), portable game consoles, palmtop computers, and other portable electronic devices. PCDs typically have complex and compact electronic packaging that is generally made of multiple processing units that include central processing units, digital signal processors, and the like. Much of this hardware may be part of a system on a chip (“SOC”) design as understood by one of ordinary skill in the art.

An individual element in an SOC may be better suited for a particular semiconductor processing node as compared to the remaining elements. Integrating all the elements into a single integrated circuit thus involves a compromise with respect to its process node. The segregation of the elements into individual chiplets thus allows the process node for each chiplet to be individually optimized for improved performance and cost. In addition, an individual chiplet in the system may be redesigned without requiring redesign of the remaining chiplets. The use of chiplets also avoids the SOC need for a relatively large die size that may result in lower yields.

Although chiplet-based systems are thus advantageous, their usage typically increases power consumption as compared to a monolithic SOC.

### SUMMARY

In accordance with an aspect of the disclosure, a chiplet-based system is provided that includes: a primary chiplet including an at least one first system client and a first power manager configured to power down the at least one first system client during a transition of the primary chiplet to a deep-sleep state; and a secondary chiplet including an at least one second system client and a second power manager configured to power down the at least one second system client during a transition of the secondary chiplet to the deep-sleep state, wherein the first power manager is further configured to command a first die-to-die control plane interface for the primary chiplet and a second die-to-die control plane interface for the secondary chiplet to both power down in response to the transition of both the primary chiplet and the secondary chiplet to the deep-sleep state.

In accordance with another aspect of the disclosure, a method for a chiplet-based system including a plurality of chiplets is provided that includes: transitioning each chiplet in the plurality of chiplets into a deep-sleep state; and powering down a die-to-die control plane interface for each chiplet in the plurality of chiplets to place the chiplet-based system in a low-power mode in response to a detection that each chiplet has entered the deep-sleep state.

Finally, in accordance with yet another aspect of the disclosure, a chiplet-based system is provided that includes: a primary chiplet having: a plurality of first system clients; a first die-to-die control plane interface; a first sideband interface; and a first power manager; and a secondary chiplet including a plurality of second system clients, wherein the first power manager is configured to command the secondary chiplet over the first sideband interface to power-up the plurality of second system clients during a transition of the chiplet-based system from a low-power mode in which the plurality of first system clients, the plurality of second system clients, and the first die-to-die control plane interface are powered down to an active mode in which the plurality of first system clients, the plurality of second system clients, and the first die-to-die control plane interface are powered up.

These and other advantageous features may be better appreciated through the following detailed description.

### BRIEF DESCRIPTION OF THE DRAWINGS

FIG. 1 illustrates a chiplet-based system in accordance with an aspect of the disclosure.

FIG. 2 is a first flowchart for an operation of a chiplet-based system in accordance with an aspect of the disclosure.

FIG. 3 illustrates a computer system formed by the chiplet-based system disclosed herein.

FIG. 4 is a second flowchart for an operation of a chiplet-based system in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

To preserve power, an integrated circuit die may collapse its power supply voltage(s) in what may be denoted as a deep-sleep mode of operation. But the use of a deep-sleep mode in a chiplet-based system may save less power as compared to forming the same functionality in a system-on-a-chip because the various chiplets may be in different power modes. One chiplet may be in a deep-sleep state but another chiplet in the chiplet-based system may be active and powered. The conflicting mode states of the various chiplets may prevent idle chiplets from transitioning to a deep-sleep state. As compared to a system-on-a-chip solution, a comparable chiplet-based system also incurs a power consumption penalty from the power consumption of the die-to-die (D2D) connections between the chiplets in both a D2D data plane and also in a D2D control plane.

To address these disadvantages, a chiplet-based system is provided in which each chiplet includes a local power manager that controls whether the resources on the chiplet are placed into light-sleep modes in which the power supply voltage(s) for the chiplet's resources is reduced from an active mode level to a light-sleep level and also controls whether the resources are isolated from the power supply voltage(s) to place them into a deep-sleep mode. In addition, each local power manager may also power down the chiplet's D2D data plane interface in conjunction with transitioning the chiplet's resources to the deep-sleep state or mode of operation. Each chiplet may thus independently transition to a deep-sleep state. But with one or more of the chiplets in a light-sleep or active state, each chiplet's D2D control plane interface may remain powered on in case the powered-on chiplet(s) needs to interact with one or more of the deep-sleep state chiplets. The active chiplet may thus use its D2D control plane interface to signal a wake-up message through a deep-sleep state chiplet's D2D control plane interface to the deep-sleep state chiplet's local power manager to cause the deep-sleep state chiplet to transition back to the active state.

Although the local power managers thus conserve power, the on-state of the various D2D control plane interfaces consume power. To achieve a “rock-bottom” power consumption state in which even the D2D control plane interfaces are powered down in a low-power mode for the chiplet-based system, a primary die in the chiplet-based system includes a primary system power manager whereas each remaining die in the chiplet-based systems is a secondary die including a secondary system power manager. Each secondary system power manager informs the primary system power manager when the secondary die has transitioned to the deep-sleep state. The primary system power manager monitors whether all the secondary dies in the chiplet-based system are in the deep-sleep state. In response to detecting that all the dies are in the deep-sleep, the primary system power manager coordinates with the secondary system power managers to shut down each die's D2D control plane interface. This coordination may begin over the D2D control plane interfaces but then be transitioned as D2D control plane interfaces are powered down to a D2D sideband signaling interface such as a sideband D2D general-purpose input/output (GPIO) interface (which may also be denoted herein as a first GPIO interface).

With the chiplet resources and the D2D data plane and control plane interfaces powered down, the system is in the low-power mode having an advantageously reduced power consumption. Each system power manager remains awake to monitor whether a wake-up signal is received over, for example, a second GPIO interface. Alternatively, each system power manager may respond to the occurrence of a wake-up event such as a reset. The wake-up signal may be received (or a wake-up event may be detected) by the primary system power manager and/or by one or more of the secondary system power managers. Should a secondary system power manager receive the wake-up signal, the secondary system power manager may proceed to alert the primary system power manager over the sideband D2D GPIO interface. The primary system power manager then coordinates with the secondary power system managers to power-up the D2D control plane interfaces. This coordination may occur initially over the sideband D2D GPIO interfaces and then transition to the D2D control plane interfaces once the D2D control plane interfaces are fully functional. With the D2D control plane interfaces functioning, the local power manager in the chiplets that are to wake up may power up their resources.

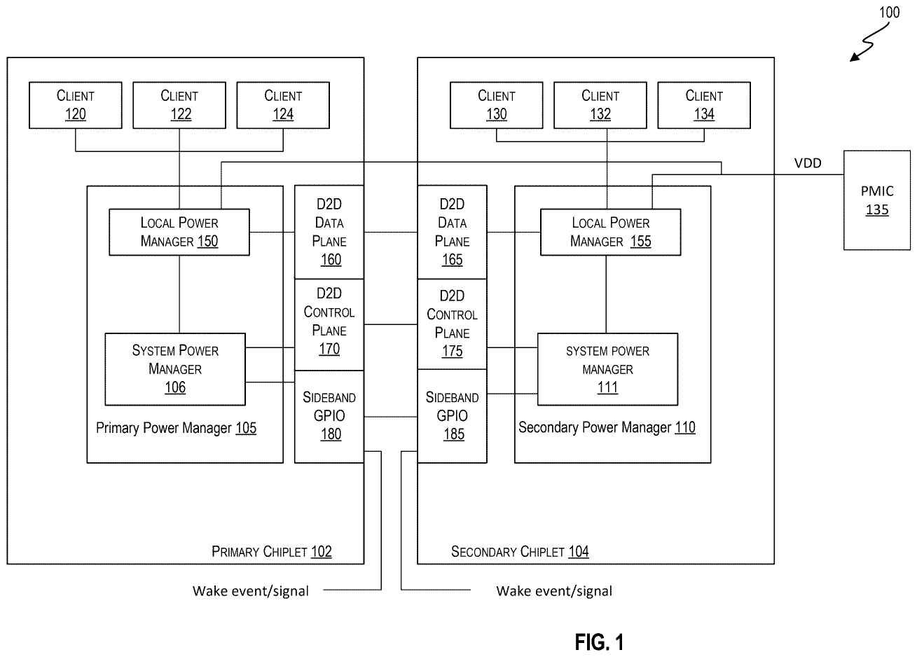

An example chiplet-based system 100 is shown in FIG. 1. In the following discussion, the chiplet-based system 100 will be assumed to employ an ARM-based architecture such that each chiplet may incorporate one or more system clients such as a central processing unit (CPU), a graphic processing unit (GPU), a digital signal processor (DSP) and so on that function as virtual machines. But it will be appreciated that any suitable computer architecture may be used to implement the chiplet-based systems disclosed herein. In system 100, a primary chiplet 102 includes a plurality of system clients such as a client 120, a client 122, and a client 124 that function as the resources whose access to a power supply voltage(s) is managed by a local power manager 150. For example, a power management integrated circuit (PMIC) 135 may distribute a power supply voltage VDD through one or more head switch transistors (not illustrated) that the local power manager 150 may switch off to place the primary chiplet clients 120, 122, and 124 into a deep-sleep mode. The local power manager 150 monitors the activity of the clients 120, 122, and 124 to determine whether they are all idle such that the local power manager may place the primary chiplet 102 into the deep-sleep state and power off the clients 120, 122, and 124. As part of placing the primary chiplet 102 into the deep-sleep state, the local power manager may power off a D2D data plane interface 160 that the clients 120, 122, and 124 use to communicate with resources in additional chiplets such as a secondary chiplet 104. The D2D interfaces (both data plane and control plane) that are disclosed herein may be formed from any suitable D2D interface such as a peripheral component interface (PCI) express interface, a secure digital input/output (SDIO) interface, a universal chiplet interconnect express (UCIe), or a serializer-deserializer (SERDES) interface.

The system 100 includes one or more secondary chiplets such as the secondary chiplet 104 that also includes a local power manager 155. The local power manager 155 monitors the activity of a plurality of system clients such as a client 130, a client 132, and a client 134. Should these clients be inactive, the local power manager 155 may transition the secondary chiplet 104 to a deep-sleep state by switching off one or more head switch transistors (not illustrated) analogously as discussed for the local power manager 150. Should the local power manager 155 transition the secondary chiplet 104 to the deep-sleep state, it may also power down a D2D data plane interface 165 that the clients 130, 132, and 134 use to communicate with resources in the other chiplets in system 100.

Referring again to the primary chiplet 102, a primary system power manager 106 monitors whether all the chiplets in system 100 have entered the deep-sleep state. Should the primary system power manager 106 detect that the all the chiplets in the system 100 are in the deep-sleep state, it begins to coordinate with system power managers in the secondary chiplets to power down D2D control plane interfaces. For example, the primary system power manager 106 may initially coordinate with a secondary system power manager 111 in the secondary chiplet 104 using a D2D control plane interface 170 that couples to a D2D control plane interface 175 in the secondary chiplet 104. As the system power managers 106 and 111 power down their respective D2D control plane interfaces 170 and 175, the coordination/signaling may move to a sideband GPIO connection. In particular, the primary system power manager 106 may continue to coordinate the transition to the low-power mode for the system 100 using a GPIO interface 180 that couples to a corresponding GPIO interface 185 in the secondary chiplet 104. This coordination may continue until all the D2D control plane interfaces are powered down so that the system 100 is in the low-power state in which all the resources and the D2D data plane interfaces are also powered down.

With the system 100 in a low-power state, the sideband GPIO interfaces 180 and 185 (or suitable die interfaces) may also function to receive a wake-up signal. Alternatively, the system power managers may respond to a wake-up event. In response to the detection of a wake-up event or the receipt of a wake-up signal to any of the system power managers, the primary system manager 106 may proceed to coordinate through the sideband GPIO interfaces 180 and 185 to begin powering up the D2D control plane interfaces 170 and 175. This coordination can be completed over the D2D control plane interfaces 170 and 175 after they are powered up. Depending upon which chiplet(s) is to be woken up, the local power managers may power up their respective D2D data plane interface and their clients. For example, if the primary chiplet 102 is to be powered up, the local power manager 150 may power up the D2D data plane interface 160 and the appropriate ones of the clients 120, 122, and 124 (note that some of the clients may remain powered down if they are to remain inactive). Similarly, if the secondary chiplet is to be powered up, the local power manager 155 may power up the D2D data plane interface 165 and the appropriate ones of the clients 130, 132, and 134.

The local power manager 150 and the system power manager 106 together form a primary power manager 105 that is also denoted herein as a first power manager. Similarly, the local power manager 155 and the system power manager 111 form a secondary power manager 110 that is also denoted herein as a second power manager. As compared to the system clients, the first and second power managers may be implemented as relatively low power embedded micro-controllers running firmware for on-ship memory, state machines, or hardware sequencers such that the first and second power managers are independent of an operating system for the system clients.

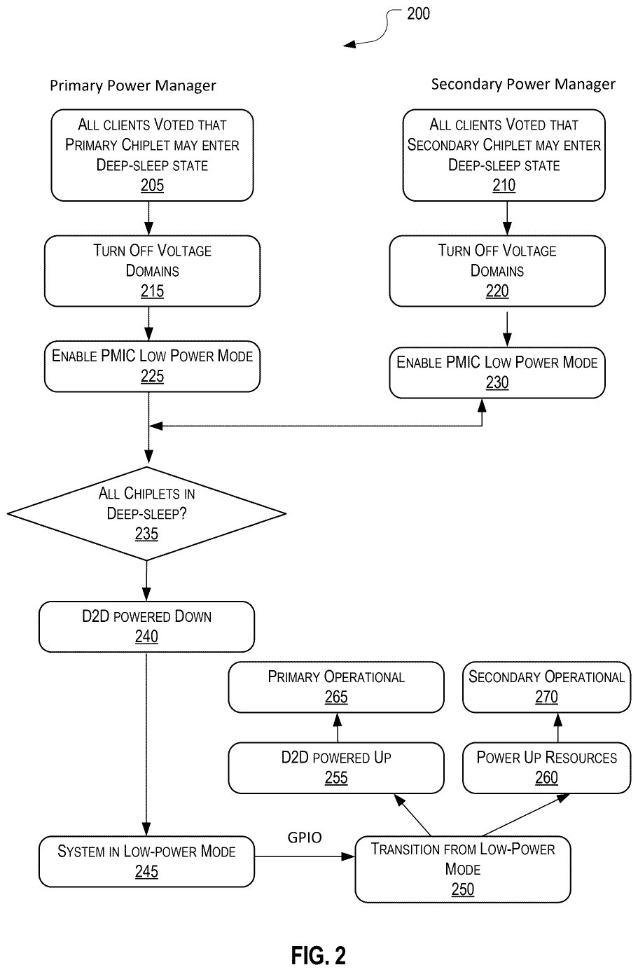

The power management by the primary and secondary chiplets will now be summarized with regard to the flowchart 200 of FIG. 2. In a step 205, the clients in the primary chiplet have all voted (indicated) to the primary power manager that the primary chiplet may enter the deep-sleep state. Similarly, in a step 210, the clients in the secondary chiplet(s) have all indicated to the secondary power manager that the secondary chiplet may enter the deep-sleep state. The voltage domains for the primary chiplet's clients and for the secondary chiplet's clients are then switched off in a step 215 and 220, respectively. With the primary chiplet and the secondary chiplet both in the deep-sleep state, the primary and secondary power managers may coordinate with the PMIC to put the PMIC in a low-power mode in steps 225 and 230, respectively. The primary power manager determines whether all the chiplets are in the deep-sleep state in a step 235. With the chiplets all in the deep-sleep state, the primary power manager coordinates with the secondary power manager to power down the D2D control plane interfaces in a step 240, which places the system in the low-power mode in a step 245. Should a wake-up signal be received over a GPIO interface in a step 250, the D2D control plane and data plane interfaces are powered up in a step 255 serially or in parallel with the powering up of the appropriate ones of the clients in the selected chiplet(s) in a step 260. Assuming that the primary chiplet was addressed by the wake-up signal, the primary chiplet becomes operational in a step 265. Similarly, the secondary chiplet(s) becomes operational in a step 270.

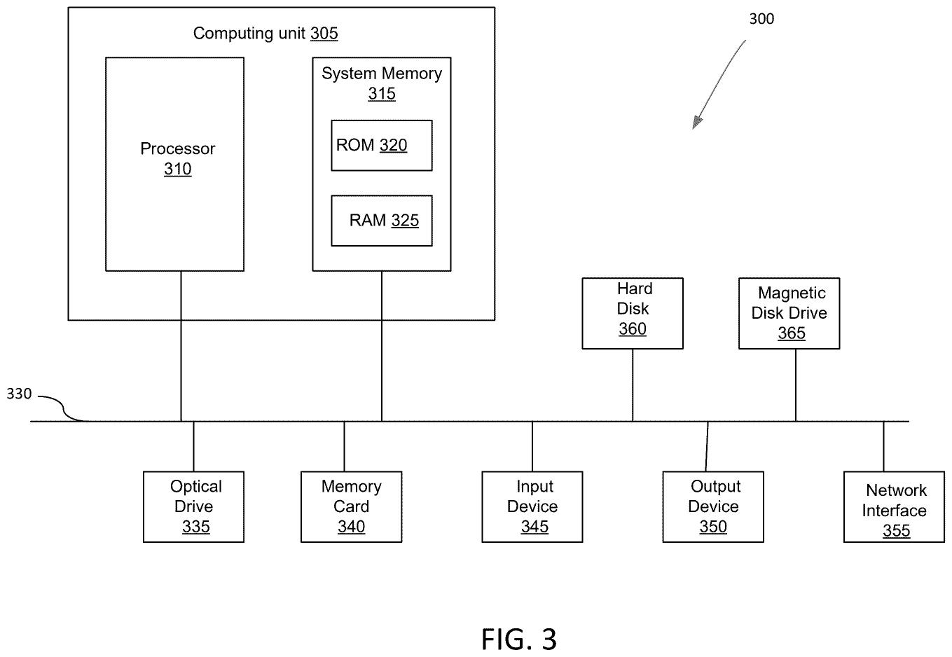

The chiplet-based systems disclosed herein may be configured to implement a computer system that includes one or more processors that implement the operating system software. An example chiplet-based computing system 300 is shown in FIG. 3. As seen in this figure, the computing system 300 includes a computing unit 305 with an at least one processor that executes instructions for the operating system software and stores data in a system memory 315. The at least one processor 310 may be any type of programmable electronic device for executing software instructions but will typically be one or more microprocessors. The system memory 315 may include both a read-only memory (ROM) 320 and a random-access memory (RAM) 325. As will be appreciated by those of ordinary skill in the art, both the read-only memory (ROM) 320 and the random-access memory (RAM) 325 may store software instructions for execution by the at least one processor 310.

The at least one processor 310 and the system memory 315 are connected, either directly or indirectly, through a bus 330 or alternate communication structure, to one or more peripheral devices. For example, the at least one processor 310 or the system memory 315 may be directly or indirectly connected to one or more additional memory storage devices, such as a “hard” magnetic disk drive 360, a removable magnetic disk drive 365, an optical disk drive 335, or a flash memory card 340. The at least one processor 310 and the system memory 315 also may be directly or indirectly connected to one or more input devices 345 and one or more output devices 350. The input devices 345 may include, for example, a keyboard, a pointing device (such as a mouse, touchpad, stylus, trackball, or joystick), a scanner, a camera, and a microphone. The output devices 345 may include, for example, a monitor display, a printer and speakers. With various examples of the computer system 300, one or more of the peripheral devices 335, 340, 345, 350, 360, and 365 may be internally housed within a housing of the computer system 300. Alternately, one or more of the peripheral devices 335, 340, 345, 350, 360, and 365 may be external to the housing and connected to the bus 330 through, for example, a Universal Serial Bus (USB) connection.

With some implementations, the computing system 300 may be directly or indirectly connected to one or more network interfaces 355 for communicating with other devices making up a network. The network interface 355 translates data and control signals from the computer system 300 into network messages according to one or more communication protocols, such as the transmission control protocol (TCP) and the Internet protocol (IP). Also, the interface 355 may employ any suitable connection agent (or combination of agents) for connecting to a network, including, for example, a wireless transceiver, a modem, or an Ethernet connection. Such network interfaces and protocols are well known in the art, and thus will not be discussed here in more detail. It should be appreciated that the computing system 300 is illustrated as an example only, and it not intended to be limiting. Various implementations may be formed using one or more computing systems that include the components of the system 300 illustrated in FIG. 3 or which include only a subset of the components illustrated in FIG. 3, or which include an alternate combination of components, including components that are not shown in FIG. 3.

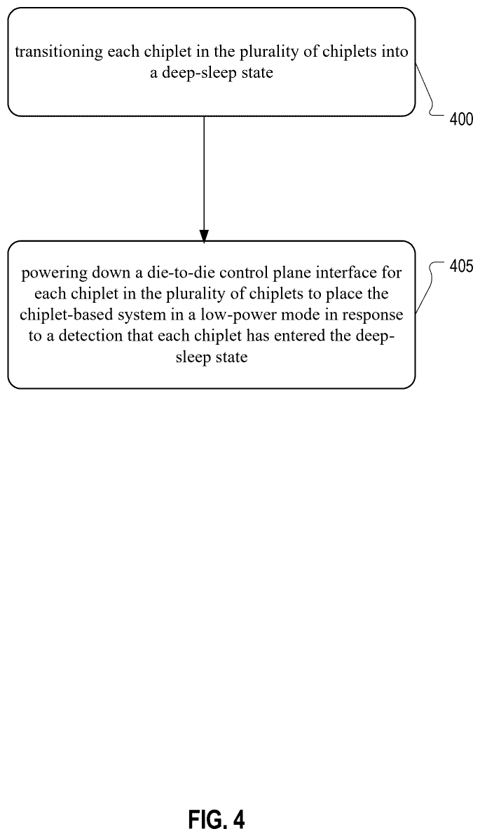

A power management method for a chiplet-based system including a plurality of chiplets will now be discussed with reference to the flowchart of FIG. 4. The method includes an act 400 of transitioning each chiplet in the plurality of chiplets into a deep-sleep state. The transition of the primary chiplet 102 and the secondary chiplet 104 into the deep-sleep state of FIG. 1 and the powering down of the chiplet voltage domains in steps 215 and 220 of FIG. 2 are examples of act 400. In addition, the method includes an act 405 of powering down a die-to-die control plane interface for each chiplet in the plurality of chiplets to place the chiplet-based system in a low-power mode in response to a detection that each chiplet has entered the deep-sleep state. The powering down of the D2D control plane interfaces 170 and 175 as discussed with regard to FIG. 1 and the powering down of the D2D control plane interfaces in step 240 of FIG. 2 are examples of act 405.

Some example implementations will now be summarized through the following numbered clauses:

Clause 1. A chiplet-based system, comprising:
a primary chiplet including an at least one first system client and a first power manager configured to power down the at least one first system client during a transition of the primary chiplet to a deep-sleep state; and
a secondary chiplet including an at least one second system client and a second power manager configured to power down the at least one second system client during a transition of the secondary chiplet to the deep-sleep state, wherein the first power manager is further configured to command a first die-to-die control plane interface for the primary chiplet and a second die-to-die control plane interface for the secondary chiplet to both power down in response to the transition of both the primary chiplet and the secondary chiplet to the deep-sleep state.
   Clause 2. The chiplet-based system of clause 1, further comprising:
a first die-to-die data plane interface for the primary chiplet, wherein the first power manager is further configured to power down the first die-to-die data plane interface during the transition of the primary chiplet to the deep-sleep state.
   Clause 3. the chiplet-based system of clause 2, further comprising:
a second die-to-die data plane interface for the secondary chiplet, wherein the second power manager is further configured to power down the second die-to-die data plane interface during the transition of the secondary chiplet to the deep-sleep state.
   Clause 4. The chiplet-based system of clause 3, wherein the first die-to-die control plane interface, the first die-to-die data plane interface, the second die-to-die control plane interface, and the second die-to-die data plane interface each comprises a peripheral component interconnect (PCI) express interface.
   Clause 5. The chiplet-based system of clause 3, wherein the first die-to-die control plane interface, the first die-to-die data plane interface, the second die-to-die control plane interface, and the second die-to-die data plane interface each comprises a secure data input/output (SDIO) interface.
   Clause 6. The chiplet-based system of clause 3, wherein the first die-to-die control plane interface, the first die-to-die data plane interface, the second die-to-die control plane interface, and the second die-to-die data plane interface each comprises a serializer-deserializer interface.
   Clause 7. The chiplet-based system of any of clauses 1-6, further comprising:
a power management integrated circuit configured to provide a power supply voltage to the at least one first system client and to the at least one second system client, wherein the first power manager is further configured to command the power management integrated circuit to power down the power supply voltage in response to the transition of both the primary chiplet and the secondary chiplet to the deep-sleep state.
   Clause 8. The chiplet-based system of any of clauses 1-7, wherein the at least one first system client comprises a plurality of first system clients, and wherein the at least one second system client comprises a plurality of second system clients.
   Clause 9. The chiplet-based system of any of clauses 1-8, further comprising:
a first sideband interface for the primary chiplet; and a
a second sideband interface for the secondary chiplet, wherein the first power manager is further configured to coordinate with the second power manager through the first sideband interface and the second sideband interface during the power down of both the first die-to-die control plane interface and the second die-to-die control plane interface.
   Clause 10. The chiplet-based system of clause 9, wherein the first sideband interface and the second sideband interface each comprises a general-purpose input/output (GPIO) interface.
   Clause 11. a method for a chiplet-based system including a plurality of chiplets, comprising:
transitioning each chiplet in the plurality of chiplets into a deep-sleep state; and
powering down a die-to-die control plane interface for each chiplet in the plurality of chiplets to place the chiplet-based system in a low-power mode in response to a detection that each chiplet has entered the deep-sleep state.
   Clause 12. The method of clause 11, wherein transitioning each chiplet into the deep-sleep state includes powering down a die-to-die data plane interface for each chiplet.
   Clause 13. The method of clause 11, wherein powering down the die-to-die control plane interface for each chiplet comprises powering down a PCI express interface for each chiplet.
   Clause 14. The method of clause 11, wherein powering down the die-to-die control plane interface for each chiplet comprises powering down an SDIO interface for each chiplet.
   Clause 15. The method of clause 11, wherein powering down the die-to-die control plane interface for each chiplet comprises powering down a serializer-deserializer interface for each chiplet.
   Clause 16. A chiplet-based system, comprising:
a primary chiplet including:
   a plurality of first system clients;
   a first die-to-die control plane interface;
   a first sideband interface; and
   a first power manager; and
a secondary chiplet including a plurality of second system clients, wherein the first power manager is configured to command the secondary chiplet over the first sideband interface to power-up the plurality of second system clients during a transition of the chiplet-based system from a low-power mode in which the plurality of first system clients, the plurality of second system clients, and the first die-to-die control plane interface are powered down to an active mode in which the plurality of first system clients, the plurality of second system clients, and the first die-to-die control plane interface are powered up.
   Clause 17. The chiplet-based system of clause 16, wherein the secondary chiplet further includes a second power manager and a second sideband interface, and wherein the second power manager is configured to control a powering up of the plurality of second system clients in response to a receipt of the command from the first power manager over the second sideband interface.
   Clause 18. The chiplet-based system of clause 17, wherein the secondary chiplet further includes a second die-to-die control plane interface, and wherein the second power manager is further configured to control a power up of the second die-to-die control plane interface in response to the receipt of the command from the first power manager over the second sideband interface.
   Clause 19. The chiplet-based system of clause 17, wherein the first sideband interface and the second sideband interface each comprises a general-purpose input/output (GPIO) interface.
   Clause 20. The chiplet-based system of any of clauses 16-19, wherein the first die-to-die control plane interface comprises one of a PCI express interface, an SDIO interface, a UCIe interface, and a serializer-deserializer.

As those of some skill in this art will by now appreciate and depending on the particular application at hand, many modifications, substitutions and variations can be made in and to the materials, apparatus, configurations and methods of use of the devices of the present disclosure without departing from the scope thereof as defined by the appended claims. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. A chiplet-based system, comprising:
a primary chiplet including an at least one first system client and a first power manager configured to power down the at least one first system client during a transition of the primary chiplet to a deep-sleep state; and
a secondary chiplet including an at least one second system client and a second power manager configured to power down the at least one second system client during a transition of the secondary chiplet to the deep-sleep state, wherein the first power manager is further configured to command a first die-to-die control plane interface for the primary chiplet and a second die-to-die control plane interface for the secondary chiplet to both power down in response to the transition of both the primary chiplet and the secondary chiplet to the deep-sleep state.

2. The chiplet-based system of claim 1, further comprising:
a first die-to-die data plane interface for the primary chiplet, wherein the first power manager is further configured to power down the first die-to-die data plane interface during the transition of the primary chiplet to the deep-sleep state.

3. The chiplet-based system of claim 2, further comprising:
a second die-to-die data plane interface for the secondary chiplet, wherein the second power manager is further configured to power down the second die-to-die data plane interface during the transition of the secondary chiplet to the deep-sleep state.

4. The chiplet-based system of claim 3, wherein the first die-to-die control plane interface, the first die-to-die data plane interface, the second die-to-die control plane interface, and the second die-to-die data plane interface each comprises a peripheral component interconnect (PCI) express interface.

5. The chiplet-based system of claim 3, wherein the first die-to-die control plane interface, the first die-to-die data plane interface, the second die-to-die control plane interface, and the second die-to-die data plane interface each comprises a secure data input/output (SDIO) interface.

6. The chiplet-based system of claim 3, wherein the first die-to-die control plane interface, the first die-to-die data plane interface, the second die-to-die control plane interface, and the second die-to-die data plane interface each comprises a serializer-deserializer interface.

7. The chiplet-based system of claim 1, further comprising:
a power management integrated circuit configured to provide a power supply voltage to the at least one first system client and to the at least one second system client, wherein the first power manager is further configured to command the power management integrated circuit to power down the power supply voltage in response to the transition of both the primary chiplet and the secondary chiplet to the deep-sleep state.

8. The chiplet-based system of claim 1, wherein the at least one first system client comprises a plurality of first system clients, and wherein the at least one second system client comprises a plurality of second system clients.

9. The chiplet-based system of claim 1, further comprising:
a first sideband interface for the primary chiplet; and a
a second sideband interface for the secondary chiplet, wherein the first power manager is further configured to coordinate with the second power manager through the first sideband interface and the second sideband interface during the power down of both the first die-to-die control plane interface and the second die-to-die control plane interface.

10. The chiplet-based system of claim 9, wherein the first sideband interface and the second sideband interface each comprises a general-purpose input/output (GPIO) interface.

11. A method for a chiplet-based system including a plurality of chiplets, comprising:
transitioning each chiplet in the plurality of chiplets into a deep-sleep state; and
powering down a die-to-die control plane interface for each chiplet in the plurality of chiplets to place the chiplet-based system in a low-power mode in response to a detection that each chiplet has entered the deep-sleep state.

12. The method of claim 11, wherein transitioning each chiplet into the deep-sleep state includes powering down a die-to-die data plane interface for each chiplet.

13. The method of claim 11, wherein powering down the die-to-die control plane interface for each chiplet comprises powering down a PCI express interface for each chiplet.

14. The method of claim 11, wherein powering down the die-to-die control plane interface for each chiplet comprises powering down an SDIO interface for each chiplet.

15. The method of claim 11, wherein powering down the die-to-die control plane interface for each chiplet comprises powering down a serializer-deserializer interface for each chiplet.

16. A chiplet-based system, comprising:
a primary chiplet including:
a plurality of first system clients;
a first die-to-die control plane interface;
a first sideband interface; and
a first power manager; and
a secondary chiplet including a plurality of second system clients, wherein the first power manager is configured to command the secondary chiplet over the first sideband interface to power-up the plurality of second system clients during a transition of the chiplet-based system from a low-power mode in which the plurality of first system clients, the plurality of second system clients, and the first die-to-die control plane interface are powered down to an active mode in which the plurality of first system clients, the plurality of second system clients, and the first die-to-die control plane interface are powered up.

17. The chiplet-based system of claim 16, wherein the secondary chiplet further includes a second power manager and a second sideband interface, and wherein the second power manager is configured to control a powering up of the plurality of second system clients in response to a receipt of the command from the first power manager over the second sideband interface.

18. The chiplet-based system of claim 17, wherein the secondary chiplet further includes a second die-to-die control plane interface, and wherein the second power manager is further configured to control a power up of the second die-to-die control plane interface in response to the receipt of the command from the first power manager over the second sideband interface.

19. The chiplet-based system of claim 17, wherein the first sideband interface and the second sideband interface each comprises a general-purpose input/output (GPIO) interface.

20. The chiplet-based system of claim 16, wherein the first die-to-die control plane interface comprises one of a PCI express interface, an SDIO interface, a UCIe interface, and a serializer-deserializer.
